(19) United States
(12) Patent Application Publication
(10) Pub. No.: US 2006/0110627 A1
(43) Pub. Date: May 25, 2006

(54) Backside coating formulation for magnetic recording tape having residual compressibility

(75) Inventors: James A. Greczyna, Vadnais Heights, MN (US); Brian D. Brong, Oakdale, MN (US); James K. Knudsen, Woodbury, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 10/996,479

(22) Filed: Nov. 22, 2004

(51) Int. Cl. G11B 5/706

(52) U.S. Cl. 428/845.3; 428/845.1; 428/844.71; 428/845.5

(57) ABSTRACT

A magnetic recording tape for data storage comprising a non-magnetic substrate having a front side and a backside, a magnetic layer formed over the front side of the substrate containing magnetic pigment particles, and a binder system therefor; the magnetic particles typically have a coercivity of at least about 2000 Oe. The substrate also has a backside coating layer formed over the backside surface of the substrate comprising at least one non-magnetic pigment and at least one binder therefor; the pigment is present in a range of from about 49% to about 55%, and the backside coating exhibits compressibility.

### THE FIELD OF THE INVENTION

The present invention relates generally to magnetic recording media such as a magnetic tape, more specifically to a formulation for a backside coating which has high compressibility during calendering and continues to exhibit compressibility during the life of the magnetic recording tape.

### BACKGROUND OF THE INVENTION

Magnetic recording media are widely used in audio tapes, video tapes, computer tapes, disks and the like. Magnetic media may use thin metal layers as the recording layers, or may comprise coatings containing magnetic particles as the recording layer. The latter type of recording media employs particulate materials such as ferromagnetic iron oxides, chromium oxides, ferromagnetic alloy powders and the like dispersed in binders and coated on a substrate. In general terms, magnetic recording media generally comprise a magnetic layer coated onto at least one side of a non-magnetic substrate (e.g., a film for magnetic recording tape applications). Such tapes are used in various formats, including wound formats, and tape packs or stacks, where multiple tape layers are positioned adjacent each other, with the backside of one layer of tape being adjacent the magnetic layer of the next layer.

Many magnetic tapes also have a backside coating applied to the opposing side of the non-magnetic substrate in order to improve the durability, electrical conductivity, and tracking characteristics of the media. As with the front coatings, the backside coatings are typically combined with a suitable solvent to create a homogeneous mixture which is then coated onto the substrate, after which the coating is dried, calendered if desired, and then cured.

The formulation for the backside coating or layer also comprises pigments and a binder system. The backside coating is important for mechanical properties. Typically the surface roughness of the backside coating is greater than that of the magnetic coating. When the magnetic recording medium is formed into a roll or pack, the pack may be compressed or subject to other environmental stresses. Under such stresses, areas of the backside coating may form impressions, i.e., emboss, the magnetic coating adjacent thereto. This embossing in the magnetic surface causes the signal-to-noise ratio to decrease, that is, the noise factor may increase due to the irregularities in the surface. Conventional back coat formulations have low pigment-to-binder ratios. This causes the coating matrix to have a low porosity; that is, most of the void space between pigment particles is filled with polymer. Such a back coat has a high resistance to compression, which exacerbates the tendency to emboss the frontcoat during compression.

In certain designs, the magnetic coating (or “front coating”) is formed as a single layer directly onto a non-magnetic substrate. In an alternative approach, the front coating is a dual-layer construction, including a support layer on the substrate and a thin magnetic layer (or “upper layer”) formed directly on the support or lower layer. With this construction, the lower layer is thicker than the magnetic layer. The support layer is typically non-magnetic and generally comprised of a non-magnetic powder dispersed in a binder. Conversely, the upper layer comprises a magnetic metal particle powder or pigment dispersed in a binder system. The formulation for the magnetic layer is optimized to maximize the performance of the magnetic recording medium in such areas as signal-to-noise ratios, pulsewidth, and the like. In such dual-layer magnetic recording media, embossing of the thin magnetic upper layer will result in lowered signal-to-noise ratios and impaired performance.

It would, therefore, be desirable to have a magnetic recording tape which separately optimizes the pigment-to-binder ratio for improved mechanical properties such as porosity, compressibility, smoothness, and reduced or eliminated embossing of the front or magnetic layer by the back coating, or backside coating.

It has now been discovered that using a backside coating having a high compressibility both during and after calendering allows continued compression during the life of the tape pack, which minimizes embossing by the back coat onto the front coating. The magnetic recording tape formed using such a backside coating will have an improved signal-to-noise ratio over magnetic recording media using conventional backside coatings.

### SUMMARY OF THE INVENTION

The invention provides a magnetic recording tape including a non-magnetic substrate, having a magnetic coating on the front side of the substrate and a backside coating on the opposing side of the substrate. The magnetic layer contains primary metallic particulate pigments, and a binder system therefor. The back coating formed on the opposing surface of the substrate has reserve porosity.

Specifically, a magnetic recording tape for data storage according to the invention comprises a non-magnetic substrate having a front side and a backside, a magnetic layer formed over the substrate's front side, which comprises magnetic pigment particles, and a binder system therefor. The substrate also has a backside coating layer formed over the backside of the substrate comprising at last one non-magnetic pigment and at least one binder therefor, wherein the pigment is present in a range of from about 49% to about 55%, (by weight of solids), and the backside coating exhibits compressibility both during and after calendaring. The backside coating includes a pore structure allowing compression of the backside coating layer.

In one embodiment, the back coat experiences compression while wound in roll form; the magnetic coating of the magnetic recording tape is at least about 5% smoother than if the magnetic recording tape had a non-compressible backside coating.

Magnetic recording tapes according to the invention have a roughness, Ra, which increases less than about 10% when temperature is increased to a maximum of about 60° C. when said tape is on a roll.

Magnetic recording tapes of the invention minimize backside embossing of the magnetic coating occurring during winding of such tape onto a roll; an increase in the average roughness (Ra) of the magnetic coating due to such embossing is less than 10%.

In making a magnetic recording tape of the invention, the backside coating is subjected to an initial compression of from about 10% to about 25% during tape manufacture, specifically during calendering of such tape.

The backside coating is also an additional compression of from about 1% to about 5% after manufacture of the magnetic recording tape.

In one embodiment, the backside coating contains a pigment mixture comprising at least alpha iron oxide and carbon black, and a binder therefor.

In another embodiment, the backside coating comprises carbon black as the pigment and a polyurethane binder therefor.

In another embodiment of the invention, the magnetic recording tape is a dual layer magnetic recording tape, further comprising a support layer coated onto the substrate, and the magnetic recording layer is coated atop the support layer.

These terms when used herein have the following meanings.

1. The term “coating composition” means a composition suitable for coating onto a substrate.

2. The terms “layer” and “coating” are used interchangeably to refer to a coated composition.

3. The terms “back coat” and “backside coating” are synonymous and refer to a coating on the opposing side of the substrate from a magnetic layer.

4. The term “vinyl” when applied to a polymeric material means that the material comprises repeating units derived from vinyl monomers. When applied to a monomeric material, the term “vinyl” means that the monomer contains a moiety having a free-radically polymerizable carbon-carbon double bond.

5. The term “resistivity” means the surface electrical resistance measured in Ohms/square.

6. The term “Tg” means glass transition temperature.

7. The term “coercivity” means the intensity of the magnetic field needed to reduce the magnetization of a ferromagnetic material to zero after it has reached saturation, taken at a saturation field strength of 10,000 Oersteds.

8. The term “Oersted”, abbreviated as Oe, refers to a unit of magnetic field in a dielectric material equal to 1/μ Gauss, where μ is the magnetic permeability.

9. The term “compression” means the irreversible collapse of pore structure of the backside coating.

All weights, amounts and ratios herein are by weight of total solids, unless otherwise specifically noted.

### DETAILED DESCRIPTION OF THE PREFERRED EMBODIMENTS

The following detailed description describes certain embodiments and is not to be taken in a limiting sense. The scope of the present invention is defined by the appended claims.

The magnetic recording tape includes a non-magnetic substrate, a magnetic layer, and a backside coating or layer. The various components are described in greater detail below. In general terms, however, the magnetic upper layer includes a primary magnetic metal pigment, and a binder for the pigment. The backside coating includes a pigment or mixture of pigments, and a binder therefor. The backside coating has a high ratio of pigment to binder, e.g., at least about 49 weight % pigment of total solids, and is compressible. In one embodiment, the magnetic recording tape may be a dual-layer magnetic recording tape having a support layer coated on the front side of the substrate, with the magnetic layer being coated atop the support layer.

The Back Coat

Back coat formulations of the invention are designed to have surplus porosity. This porosity allows high compressibility when the back coat is calendered during processing of the magnetic recording tape, but also provides a porosity reserve that remains after the calendering processes are completed, and provides extended stress relief to the entire tape pack by continued compression of the back coat for the full life of the tape.

The back coat contains at least one non-magnetic particle material such as carbon black, iron oxides, titanium dioxide, alumina, tin oxide, titanium carbide, silicon carbide, silicon dioxide, silicon nitride, boron nitride, and the like. Carbon black is widely commercially available. Alpha-iron oxides are well known and are commercially available from Dowa Mining Company, Toda Kogyo, Sakai Chemical Industry Co, and others. The back coat formulation preferably contains from about 2% to about 6% by weight percent carbon. The back coat preferably includes a mixture of pigments including carbon black, and from about 47% to about 63% by weight of alpha iron oxide, and from about 0.5% to about 6% of alumina, along with from about 13% to about 25% of titanium dioxide.

Back coat pigments are dispersed as inks with appropriate binders, surfactant, ancillary particles, and solvents. Preferably, the back coat binder includes at least one polyurethane resin and one hard resin. The soft urethane resin generally comprises from about 4% to about 12% by weight of the back coat formulation, and the hard binder comprises from about 3% to about 14% by weight of the formulation. The percentages are weight percents of the solids in the formulation. The backside coating of the invention has a hardness which is less than the hardness of said magnetic layer.

The pigment is present in the backside coating in amounts of from about 49% to about 55% of the coating composition. The backside coating has a pore structure which allows compression of the backside coating layer. This compression absorbs stress during calendering and winding of the tape and significantly reduces the amount of embossing of the magnetic layer by the back coat onto the adjacent front magnetic coating during such procedures. Backside coating is subjected to radial stress of from about 100 psi to about 2000 psi during winding procedures. Magnetic recording tapes of the invention have a back coat wherein the magnetic coating is at least about 5% smoother than in an otherwise identical magnetic recording tape not having a compressible back coating; in some embodiments, the magnetic coating is from 5% to about 20% smoother than such a comparative tape. The tapes of the invention are subject to an initial compression of from about 10% to about 25% during tape manufacture, and subjected to an additional compression of from about 1% to about 5% during winding.

The Magnetic Recording Layer

In accordance with the current invention, the magnetic recording layer is a thin layer, being preferably from about 25 nm to about 250 nm in thickness, preferably from about 25 nm to about 200 nm.

The magnetic metal particle pigments have a composition including, but not limited to, metallic iron and/or alloys of iron with cobalt and/or nickel, and magnetic or non-magnetic oxides of iron, other elements, or mixtures thereof. Alternatively, the magnetic particles can be composed of hexagonal ferrites such as barium ferrites.

In addition to the preferred primary magnetic metal particle pigment described above, the magnetic layer may further include other particles such as carbon black.

The magnetic layer also includes an abrasive or head cleaning agent (HCA) component. One preferred HCA component is aluminum oxide. Other abrasive grains such as silica, ZrO₂, Cr₂O₃, etc., can also be employed, either alone or in mixtures with aluminum oxide or each other.

The binder system associated with the magnetic layer preferably incorporates at least one binder resin, such as a thermoplastic resin, in conjunction with other resin components such as binders and one or more hardeners. The magnetic layer may further contain one or more lubricants such as a fatty acid and/or a fatty acid ester. The incorporated lubricant(s) exists throughout the front coating and, importantly, at the surface thereof the magnetic layer. The lubricant(s) reduces friction to maintain smooth contact with low drag and protects the media surface from wear. In dual-layer media, lubricant(s) are generally provided in both the upper and lower layers, and are preferably selected and formulated in combination.

In a preferred embodiment, the lubricant is incorporated into the magnetic layer in an amount of from about 1 to about 10 parts by weight, and preferably from about 1 to about 5 parts by weight, based on 100 parts by weight of the primary pigment.

The binder system may also contain a conventional surfactant or wetting agent. Known surfactants, e.g., adducts of sulfuric, sulfonic, phosphoric, phosphonic, and carboxylic acids, are acceptable.

The coating composition may also contain a hardening agent such as isocyanate or polyisocyanate. In a preferred embodiment, the hardener component is incorporated into the upper layer in an amount of from about 1 to about 5 parts by weight, and preferably from about 1 to about 3 parts by weight, based on 100 parts by weight of the primary magnetic pigment.

The materials for the magnetic layer are mixed with the primary pigment and coated atop the lower layer. Useful solvents associated with the upper layer coating material preferably include cyclohexanone (CHO), methyl ethyl ketone (MEK), and toluene (Tol). Alternatively, other solvents or solvent combinations including, for example, xylene, methyl isobutyl ketone, tetrahydrofuran, and methyl amyl ketone, are acceptable.

The Support Layer

The optional support layer of a dual-layer magnetic tape of the invention is essentially non-magnetic and includes non-magnetic powders, and a resin binder system. By forming one or more essentially non-magnetic lower layers, the electromagnetic characteristics of the magnetic layer are not adversely affected.

An optional lower layer of magnetic recording media of the invention includes at least one pigment and a binder system therefor. Such support layers are used in combination with an upper magnetic layer to form a magnetic recording tape having high quality recording characteristics and good mechanical and handling properties. The primary lower layer pigment material consists primarily of non-magnetic particles such as iron oxides, titanium dioxide, alumina, tin oxide, titanium carbide, silicon carbide, silicon dioxide, silicon nitride, boron nitride, and the like. In a preferred embodiment, the primary lower layer pigment material is a hematite material (α-iron oxide).

Conductive carbon black material provides a certain level of conductivity so as to provide the formulation with protection from charging with static electricity. In one preferred embodiment, the conductive carbon black material has an average particle size of less than 20 nm, more preferably about 15 nm.

The support or lower layer may also include an abrasive pigment such as aluminum oxide. Other abrasive grains such as silica, ZrO₂, Cr₂O₃, etc., can also be employed, either alone or in mixtures with aluminum oxide. Such pigments are frequently referred to as head cleaning agents (HCA) due to the abrasive nature of the pigments.

The binder system or resin associated with the lower layer preferably incorporates at least one binder resin, such as a thermoplastic resin, in conjunction with other components. The binder system may also contain a surfactant or wetting agent. Known surfactants, e.g., adducts of sulfuric, sulfonic, phosphoric, phosphonic, and carboxylic acids, are acceptable. The binder system may also contain a hardening agent such as isocyanate or polyisocyanate. Additional components may include binders and surfactants used to disperse the HCA.

In one embodiment, the binder systems of the support layer contain a hard resin along with a soft resin. The soft resin has a Tg of less than about 60° C., preferably less than about 50° C. The hard resin has a Tg of at least about 70° C., preferably at least about 80° C.

The support layer may further contain one or more lubricants such as a fatty acid and/or a fatty acid ester. Acceptable fatty acids include stearic acid, myristic acid, palmitic acid, oleic acid, etc., and their mixtures. The support layer formulation can further include a fatty acid ester such as butyl stearate, isopropyl stearate, butyl oleate, butyl palmitate, butyl myristate, hexadecyl stearate, and oleyl oleate. The fatty acids and fatty acid esters may be employed singly or in combination.

The materials for the lower layer are mixed with the primary pigment and the lower layer is coated to the substrate. Useful solvents associated with the lower layer coating material preferably include cyclohexanone (CHO), methyl ethyl ketone (MEK, and toluene (Tol). Alternatively, other solvents or solvent combinations can be employed including, for example, xylene, methyl isobutyl ketone, tetrahydrofuran, and methyl amyl ketone.

Substrate

The substrate can be any conventional non-magnetic substrate useful as a magnetic recording tape support. Exemplary substrate materials useful for magnetic recording tapes include polyesters such as polyethylene terephthalate, polyethylene naphthalate (PEN), a mixture of polyethylene terephthalate and polyethylene naphthalate; polyolefins (e.g., polypropylene); cellulose derivatives; polyamides; and polyimides. In a preferred embodiment, polyethylene naphthalate (PEN) is employed.

Process for Tape Manufacture

The coating materials of the upper layer, lower layer, and back coat for a magnetic recording tape according to the present invention are prepared by dispersing the corresponding powders or pigments and the binders in a solvent. For example, with respect to the coating material for the upper layer, the primary metal particle powder or pigment and the large particle carbon materials are placed in a high solids mixing device along with certain of the resins (i.e., polyurethane binder, non-halogenated vinyl binder, and surfactant) and the solvent, and processed. Following this processing, the resulting composition is subjected to a sandmilling or polishing operation. Subsequently, the HCA and related binder components are added. Following this procedure, the composition is processed through a filtration operation, and then the hardener component and lubricants are added. The resulting upper layer coating material is then ready for coating.

Preparation of a support layer coating material, when such a layer is used, entails a similar process, including high solids mixing of the pigment combination including the primary lower layer pigment, conductive carbon black material, and HCA with the binder resins and solvent.

Finally, preparation of the back coat coating material preferably entails mixing the various components, including a solvent, in a planetary mixer or similar device, and then subjecting the dispersion to a sandmilling operation. Subsequently, the material is processed through a filtration operation in which the material is passed through a number of filters.

The substrate is coated with the back coating on one side of the substrate and the front coat layer(s) on the other side of the substrate. The coatings are dried, using suitable ovens. The coated substrate then proceeds to the calendering station. Calendering provides a desired degree of smoothness to the magnetically coated side of the substrate. The coated, calendered substrate is then slit, tested for defects and wound into final product form.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

### EXAMPLE 1

The examples show three formulations with different levels of pigment loading. As can be seen, the high pigment back coats of the tapes of the invention exhibit high porosity. The high level of porosity is indicated by pore volume and surface area. The high porosity level allows for maximum compression. Maximum compression produces the smoothest surface.

Example 1 has pigment loading of 75 wt %, pore volume is 0.00799 cc/gm, low compression, and surface roughness average of 15.1 nm.

Example 2 has pigment loading of 78 wt %, pore volume is 0.01300 cc/gm, medium compression, and surface roughness average of 14.9 nm.

Example 3 has pigment loading of 81 wt %, pore volume is 0.01493 cc/gm, high compression, and surface roughness average of 12.2 nm.

TABLE 1

| | Weight % solids | | |
|---|---|---|---|
| RAW MATERIAL | Example 1 | Example 2 | Example 3 |
| Total pigment weight % loading | 74.65 | 78.07 | 81.13 |
| Total pigment volume % loading | 44.56 | 49.12 | 53.65 |
| MR 113 PVC hard binder | 8.67 | 7.38 | 6.22 |
| UR 7300 soft urethane binder | 8.67 | 7.38 | 6.22 |
| DBNB 6513 Alpha Iron Oxide | 51.56 | 53.91 | 56.03 |
| Ketjin EC600JD carbon | 2.85 | 2.98 | 3.10 |
| Ceralox APA 0.2 alumina | 3.05 | 3.20 | 3.32 |
| R960 TiO2 | 17.19 | 17.98 | 18.68 |
| Stearic acid | 1.86 | 1.94 | 2.01 |
| CB 55N activator | 6.15 | 5.23 | 4.41 |
| Total Solids | 100 | 100 | 100 |
| Solvents MEK TOL CHO 75:20:5 | | | |
| Pore Volume cc/gm | 0.00799 | 0.0130 | 0.01493 |
| BET Surface Area m2/gm | 1.0378 | 1.6970 | 2.3431 |
| % Compression at calendering | 5 | 24 | 25 |
| % Compression after calendering | 1 | | 5 |
| Surface roughness average, | 15.1 | 14.9 | 12.2 |
| Wyko Ra nm | | | |

TABLE 2

| | Range in weight % solids | | |
|---|---|---|---|
| RAW MATERIAL | Example 1 | Example 2 | Example 3 |
| Total pigment weight loading | 70.0-86.0 | 74.0-84.0 | 78.0-83.0 |
| Total pigment volume loading | 40.0-56.0 | 43.0-54.0 | 45.0-53.0 |
| MR 113 PVC hard binder | 3.0-14.0 | 4.0-9.0 | 5.0-7.0 |
| UR 7300 30% solids soft urethane | 4.0-12.0 | 5.0-10.0 | 6.0-8.0 |
| binder | | | |
| DBNB 6513 Alpha Iron Oxide | 47.0-63.0 | 51.0-60.0 | 55.0-57.0 |
| Ketjin EC600JD carbon | 2.0-6.0 | 2.5-5.0 | 3.0-4.0 |
| Ceralox APA 0.2 alumina | 0.5-6.0 | 2.0-5.0 | 3.0-4.0 |
| R960 TiO2 | 13.0-25.0 | 15.0-23.0 | 17.0-20.0 |
| Stearic acid | 0.50-4.00 | 1.00-3.00 | 1.50-2.50 |
| CB 55N @ 55% solids activator | 2.0-8.0 | 3.0-7.0 | 4.0-6.0 |

1. A magnetic recording tape for data storage comprising a non-magnetic substrate having a front side and a backside, a magnetic layer formed over said front side of said substrate, said magnetic layer comprising magnetic pigment particles, and a binder system therefor; said substrate also having a backside coating layer formed over said backside of said substrate comprising at least one non-magnetic pigment and at least one binder therefor, said pigment being present in a range of from about 74 weight % to about 86 weight % based on total solids, said pigment including from about 47 weight percent to about 63 weight percent alpha-iron oxide, and from about 2 weight percent to about 6 weight percent of carbon black, wherein said backside coating includes a pore structure allowing compression of the backside coating layer, and exhibits compressibility after calendaring.

2. (canceled)

3. A magnetic recording tape, according to claim 1, wherein the back coat is subjected to compression of from about 10% to about 25% during tape manufacture, and subjected to an additional compression of from about 1% to about 5%, and a radial stress of from about 100 psi to about 2000 psi during winding of said magnetic recording tape onto a roll, wherein said magnetic coating is at least about 5% smoother than in an otherwise identical magnetic recording tape having a non-compressible backside coating.

4. A magnetic recording tape according to claim 3, wherein said magnetic coating is from about 5% to about 20% smoother than in an otherwise identical magnetic recording tape having a non-compressible backside coating.

5. A magnetic recording tape according to claim 3 having a surface roughness, Ra, which increases less than about 10% when temperature is increased to a maximum of about 60° C. when said tape is on a roll.

6. A magnetic recording tape according to claim 3 wherein said tape exhibits minimal backside embossing of the magnetic coating occurring during winding of said tape onto a roll such that an increase in the average roughness (Ra) of the magnetic coating due to said embossing is less than 10%.

7. (canceled)

8. (canceled)

9. (canceled)

10. A magnetic recording tape according to claim 3, wherein said tape after being wound on a roll has less than 10% variation in Ra from embossing between tape on an outside surface of said roll and tape on an inside surface of said roll.

11. A magnetic recording tape according to claim 1, wherein the backside coating has a hardness less than the hardness of said magnetic layer.

12. A magnetic recording tape according to claim 1, wherein the back coat comprises a carbon black pigment and a urethane binder.

13. A magnetic recording tape according to claim 12, wherein the back coat further comprises at least one metal oxide selected from the group consisting of titanium dioxide, alum oxide, and mixtures thereof.

14. A magnetic recording tape according to claim 13, wherein the backside coating comprises from about 2% to about 6% by weight carbon black, and from about 47% to about 63% by weight of alpha iron oxide, and from about 0.5% to about 6% by weight of alumina, along with from about 13% to about 25% by weight of titanium dioxide.

15. A magnetic recording tape according to claim 14, wherein said backside coating formulation further includes a polyvinyl chloride resin.

16. A magnetic recording tape according to claim 1, wherein said backside coating layer has a thickness of from about 0.25 micron to about 1.0 micron.

17. A magnetic recording tape according to claim 1, wherein the magnetic layer comprises a ferromagnetic pigment, aluminum oxide, a spherical particle carbon material, a polyurethane binder, a non-halogenated vinyl binder, a hardener, a fatty acid ester lubricant, and a fatty acid lubricant.

18. A magnetic recording tape according to claim 17, wherein said magnetic pigments in said magnetic layer have a coercivity of at least about 2000 Oersteds.

19. A magnetic recording tape according to claim 1, wherein said backcoat layer has a pore volume of from about 0.00799 to about 0.0149 gm/cc.
